(19) United States
(12) Patent Application Publication
(10) Pub. No.: US 2004/0237671 A1
(43) Pub. Date: Dec. 2, 2004

(54) Gas sampling apparatus

(75) Inventor: Scott Ryan, Ocala, FL (US)

Correspondence Address: FOLEY & LARDNER, 777 EAST WISCONSIN AVENUE, SUITE 3800, MILWAUKEE, WI, 53202-5308, US

(73) Assignee: Zefon International, Inc.

(21) Appl. No.: 10/857,240

(22) Filed: May 28, 2004

Related U.S. Application Data
(60) Provisional application No. 60/473,841, filed on May 28, 2003.

(51) Int. Cl. G01N 1/00

(52) U.S. Cl. 73/863.01

(57) ABSTRACT

An air sampling apparatus includes a casing having a battery provided therein and means for attaching a sampling cassette to the casing. An impeller draws air through the sampling cassette. Power is provided to the impeller by a battery. A microprocessor included in the air sampling apparatus is configured to activate the impeller in accordance with a programmed sampling schedule.

### CROSS-REFERENCE TO RELATED APPLICATIONS

This application claims the benefit under 35 U.S.C. § 119(e) of U.S. Patent Application No. 60/473,841 filed May 28, 2003, the disclosure of which is incorporated herein by reference in its entirety.

### FIELD

The present invention relates generally to the field of gas sampling devices (e.g., air sampling devices). More specifically, the present invention relates to programmable battery-powered gas-borne matter sampling devices.

### BACKGROUND

Gas sampling devices (e.g., air sampling devices) are generally used to determine the quantity and types of matter present in air or other gaseous atmospheres. For example, in a factory where materials are used that may be detrimental to human health, it may be desirable to quantify the amount and types of matter present in the atmosphere so that factory workers are not exposed to unsafe or undesirable levels of airborne materials. One type of known air sampling device is a vacuum pump type air sampling device that is powered by an alternating current (AC) power source (e.g., a power cord connected to a wall electrical outlet). Suction generated by the vacuum pump forces air into the sampling device to allow detection of airborne matter.

One difficulty with such known air sampling devices is that various components of the air sampling devices (e.g., the vacuum pump) add weight to the devices, such that moving the devices between a variety of locations is relatively difficult. For example, such known devices may weigh between approximately 15 and 20 pounds. Where a battery is provided to power known air sampling devices, a relatively large and heavy battery (e.g., a 12 volt automotive battery) has been used, which may add 40 pounds or more to the weight of the device, significantly reducing portability of the device. Other known air sampling devices may have dimensions that make it relatively difficult to conveniently move the devices between a variety of locations.

Another reason for the relative difficulty in moving such known air sampling devices to a desired location is that such devices may require the presence of an AC power source. Placement of the air sampling device is thus limited by the proximity to an electrical outlet and the length of the power cord and any extension cords that may be available.

Another difficulty with known air sampling devices is that such devices may emit a relatively large amount of noise during operation. Motors provided to operate vacuum pumps in such devices may contribute to the noise output.

Yet another difficulty with known air sampling devices is that typically such devices may only be used to perform continuous “always on” type sampling. For example, such devices may be programmed to sample the air in a particular location for 2 hours, during which time the vacuum pump operates continuously. One disadvantage of such an arrangement is that such continuous operation may require a relatively large amount of power. Another disadvantage is that the capacity of sample collectors provided in the sampling devices may be insufficient to retain all material collected during the sampling period. For example, it may be important to understand the amount and/or types of material present in the air over a period of time (e.g., several days). Thus, it may be sufficient to obtain air samples at several points during the sampling period. Continuous sampling during this time, however, may fill a sample collector such that data from the end of the sampling period is lost.

Thus, there is a need to provide an air sampling device or apparatus that has a weight and size that allow the apparatus to be relatively easily moved between a variety of locations. There is also a need to provide an air sampling apparatus that is relatively portable and that may be placed in locations without regard to the presence or proximity of an alternating current power source. There is further a need for an air sampling apparatus that emits a decreased amount of noise as compared to known devices. There is further a need to provide an air sampling apparatus that may be configured to sample air or other gaseous atmospheres over a period of time in a discontinuous manner. There is further a need to provide a method of programming and operating an air sampling apparatus that allows for discontinuous air sampling over a predetermined period of time.

It would be desirable to provide a system and/or method that provides one or more of these or other advantageous features. Other features and advantages may be made apparent from the present specification. The teachings disclosed extend to those embodiments which fall within the scope of the appended claims, regardless of whether they accomplish one or more of the above-described needs.

### SUMMARY

An exemplary embodiment relates to an air sampling apparatus. The air sampling apparatus includes a housing (e.g., a body or casing) and a sampling cassette coupled to the air sampling apparatus. The air sampling apparatus also includes an impeller provided within the housing and configured to draw air through the sampling cassette during a sampling cycle and a battery providing power to the impeller. The sampling apparatus may be programmed to perform a plurality of sampling cycles during a sampling period using a single sampling cassette, the plurality of sampling cycles being separated by a predetermined time interval.

Another exemplary embodiment relates to an air sampling device. The air sampling devices includes a casing having a battery provided therein, means for attaching a sampling device to an exterior surface of the casing, and an impeller for drawing air through the sampling device when the sampling device is attached to the housing. A rechargeable battery provides power to the impeller. The air sampling devices further includes a microprocessor configured to activate the impeller in accordance with a programmed sampling schedule. The programmed sampling schedule includes a plurality of sampling cycles during which the impeller is activated and a plurality of inter-cycle periods during which the impeller is deactivated.

A further exemplary embodiment relates to a portable air sampling apparatus configured for use with a disposable air sampling cartridge. The air sampling apparatus includes a casing configured for removably coupling with the air sampling cartridge and a battery that provides power to the air sampling apparatus. The battery is a rechargeable battery. The air sampling apparatus also includes an impeller fan provided within the casing to draw air through the sampling cartridge when the impeller fan is rotated and a microprocessor configured to rotate the impeller fan in accordance with a programmed schedule. The programmed schedule includes a plurality of sampling cycles during which the impeller fan is rotated and a plurality of inter-cycle periods during which the impeller fan is not rotated.

Alternative exemplary embodiments relate to other features and combinations of features as may be generally recited in the claims.

### BRIEF DESCRIPTION OF THE DRAWINGS

FIG. 1 is a perspective view of an air sampling apparatus having a sampling cassette provided thereon according to an exemplary embodiment.

FIG. 2 is an exploded perspective view of a portion of the air sampling apparatus shown in FIG. 1 having the sampling cassette removed therefrom and shown in an exploded view.

FIG. 3 is a rear plan view of the air sampling apparatus shown in FIG. 1.

FIG. 4 is a top plan view showing the interior of the air sampling apparatus shown in FIG. 1.

FIG. 5 is an exploded perspective bottom view of the cassette shown in FIG. 1.

FIG. 6 is a cross-sectional view of the sampling cassette shown in FIG. 1.

FIG. 7 is a flow diagram showing a method of programming the air sampling apparatus shown in FIG. 1 according to an exemplary embodiment.

FIG. 8 is a flow diagram showing a method of sampling air using the air sampling apparatus shown in FIG. 1 according to an exemplary embodiment.

### DETAILED DESCRIPTION OF THE EXEMPLARY EMBODIMENTS

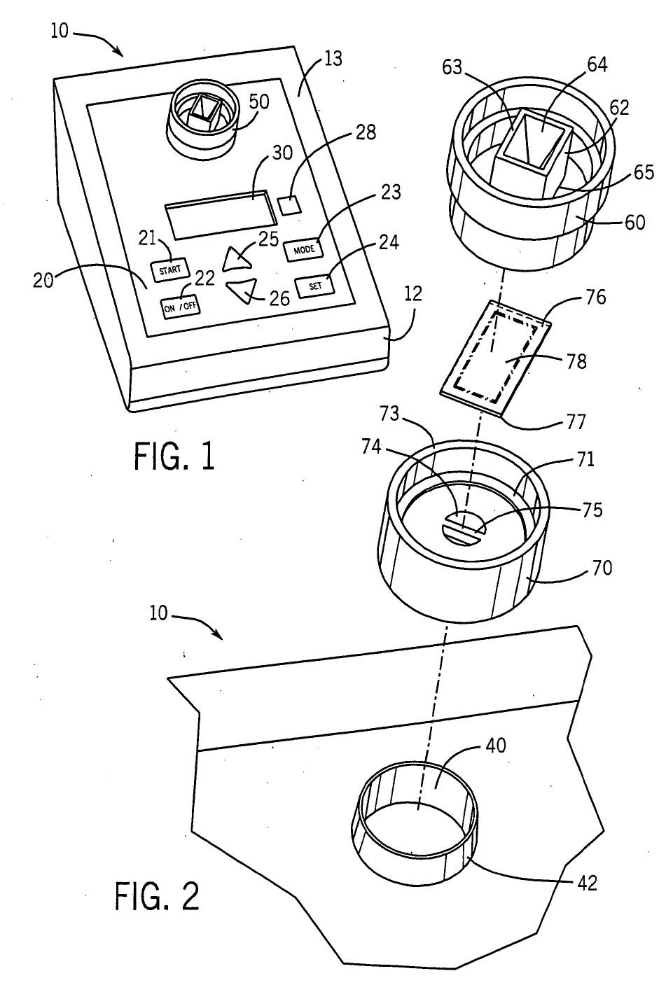

Referring to FIGS. 1-4, a gas sampling apparatus or device 10 (e.g., an air sampling apparatus or device) according to an exemplary embodiment is shown. Sampling apparatus 10 includes a casing or housing 12 in which an impeller 80 is provided. Impeller 80 includes a motor that acts to rotate an impeller fan (e.g., a backpressure blower fan). The impeller fan may include one or more blades angled with respect to the axis of rotation of the fan and configured to draw air into the sampling apparatus. A top surface 13 of housing 12 includes a hole or aperture 40 and a rubber grommet or ring 42 at least partially surrounding the aperture 40. A sampling cassette or cartridge 50 (e.g., a particle impaction device or unit) is coupled to the grommet 42 to position the cartridge 50 over the aperture 40.

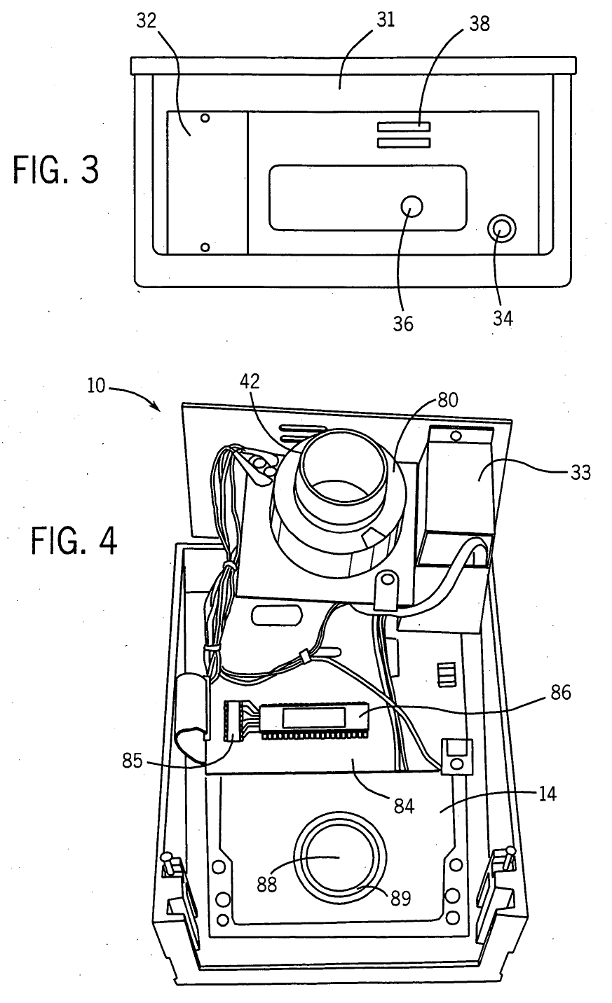

When sampling apparatus 10 is operating in a sampling mode, impeller 80 rotates at a relatively high speed to draw air from the surrounding atmosphere through cassette 50. To keep the motor (not shown) that drives impeller 80 relatively cool during operation, at least one vent or aperture 38 (FIG. 3) is provided in a rear panel or surface of sampling apparatus 10.

As shown in FIG. 4, an aperture or hole 88 is provided in a bottom surface 14 of housing 12. Aperture 88 is configured to allow coupling of housing 12 with a platform or tripod (not shown). A portion of the platform or tripod may include features that complement or mate with a rim or border 89 of aperture 88 to secure the platform or tripod to housing 12. The platform or tripod allows for elevation of sampling apparatus 10 above the ground or other surface. One advantageous feature of providing for elevated positioning of sampling apparatus 10 is that the height of sampling apparatus 10 may be adjusted relative to the floor or other surface to obtain air samples at a desired height. For example, matter included in the air may vary with increasing distance from the ground or other surface, such that heavier particles may be present in air located closer to the ground, while lighter particles may be present at higher altitudes.

Sampling device 10 includes a circuit board or motherboard 84 (FIG. 4) to which a microprocessor 86 is coupled. Microprocessor 86 can be a microcontroller, application-specific integrated circuit (ASIC), or other digital and/or analog circuitry configured to perform the functions disclosed herein. According to an exemplary embodiment, a memory chip 85 is provided on circuit board 84 that is configurable with software to perform the functions disclosed herein. According to another exemplary embodiment, microprocessor 86 includes a memory (e.g., non-volatile memory) configurable with software to perform the functions disclosed herein. According to an exemplary embodiment, the microprocessor includes an integrated clock or clocking device to provide a time input to microprocessor 86 (e.g., to calculate the amount of time elapsed during a particular sampling cycle). According to an alternative embodiment, a separate clock or clocking device is provided.

Microprocessor 86 is programmed to provide signals (e.g., digital signals) to various features of sampling apparatus 10. For example, microprocessor 86 may communicate with impeller 80 to activate impeller 80. According to an exemplary embodiment, microprocessor 86 is programmed by a user (e.g., using input device 28) to turn the impeller motor on and off at various times during a sampling period. Such programming allows a number of sampling cycles to be run during a sampling period (e.g., five hours or more) that are spaced apart by a predetermined amount of time (e.g., an inter-cycle time), as will be described in greater detail below.

Sampling apparatus 10 is relatively small and lightweight as compared to conventional air sampling devices. According to an exemplary embodiment, sampling apparatus 10 weighs less than approximately 5.0 pounds and preferably between approximately 2.0 and 4.0 pounds. Sampling apparatus 10 has a width of approximately 15.5 centimeters, a depth of approximately 20 centimeters, and a height of approximately 10 centimeters. According to alternative embodiments, the weight and dimensions of a sampling apparatus may differ. For example, a sampling apparatus may have a different shape than the sampling apparatus illustrated in FIGS. 1-4, which may alter the dimensions from the preferred and exemplary embodiments described above.

Sampling apparatus 10 may receive power from a direct current (DC) and/or an alternating current (AC) power source. According to a preferred embodiment, sampling apparatus 10 includes a rechargeable battery (not shown). As best shown in FIGS. 3 and 4, a battery cover or door 32 is provided on a rear or back surface 31 of housing 12. Battery door 32 may be removed to allow insertion and/or removal of a battery from a battery housing or container 33 that is provided within housing 12. For example, a number of screws may be provided to secure door 32 to housing 12 such that to remove the battery, the screws must be rotated to loosen the screws. In another example, a hinged door structure may be provided that allows for relatively simple removal of the battery from the housing. Any of a variety of means for securing a door to the housing may be used according to other alternative embodiments.

Any of a variety of rechargeable battery sizes and/or types may be used with sampling apparatus 10 (e.g., a nickel metal hydride battery, a lithium-ion battery, a nickel cadmium battery, etc.). According to an exemplary embodiment, the battery is a nickel metal hydride battery. The battery allows for operation of the impeller to provide a flow rate of approximately 15 liters per minute. According to other exemplary embodiments, the flow rate may be between approximately 2 and 30 liters per minute. One advantageous feature of providing a battery as a power source for sampling apparatus 10 is that sampling apparatus 10 is relatively portable or movable to a desired location, and is not constrained by location of AC power sources (e.g., wall sockets). As compared to larger batteries (e.g., 12 volt automotive batteries), the battery provided to power air sampling apparatus 10 has a weight that advantageously allows for increased portability.

Sampling apparatus 10 may be configured to sample air at a rate of approximately 15 liters per minute (e.g., between approximately 10 and 20 liters per minute). Such sampling rate has conventionally been achieved only by AC sampling devices that utilize vacuum pump type suction devices. Use of a battery as a power source also allows sampling apparatus 10 to emit a relatively low amount of noise during operation.

A charging jack or port 34 is provided in the rear or back surface 31 of housing 12 to allow charging of the battery from an AC power source. Such charging jack may include or be coupled to an alternating current to direct current (AC-DC) converter to allow charging of a DC battery from an AC power source. A light or lamp 36 (e.g., a light emitting diode) is provided to indicate charging of-the battery. According to an exemplary embodiment, lamp 36 turns off to indicate a full charge condition of the battery. According to alternative embodiments, the lamp may flash or another separate lamp may provided and lit to indicate a full charge condition.

The amount of time necessary to fully charge a battery provided in the sampling device may vary depending on the amount of remaining charge in the battery and on the capacity and type (e.g., nickel-metal-hydride, lithium ion, etc.) of battery provided. According to an exemplary embodiment, the nickel metal hydride battery has a charging time to reach a fully charged condition of between approximately 2 and 3 hours. According to alternative embodiments, other charging times may be required. According to other alternative embodiments, a separate charging device may be provided to allow for charging of the battery (e.g., where no alternating current source may be used in conjunction with the sampling device or where the alternating current power jack provided in the sampling device is not configured to charge the battery).

According to other alternative embodiments, non-rechargeable batteries or AC power sources may be used to provide power to sampling apparatus 10. For example, upon complete discharge of a non-rechargeable battery, a new battery having either a complete or partial remaining charge may be provided to power the sampling apparatus. Where an AC power source is used, the charging jack may act as a power input jack, such that a plug connected to the charging jack may be plugged into a wall socket or other power source to provide power to the sampling apparatus.

According to an exemplary embodiment, sampling apparatus 10 shuts down or stops sampling when the battery capacity has reached a predetermined threshold. According to an exemplary embodiment, sampling apparatus 10 detects the remaining capacity of the battery and determines whether the sampling apparatus is able to operate at a constant speed (e.g., whether impeller 80 will be rotated at a constant speed). When the sampling apparatus cannot operate at a constant speed, a low battery power indication (e.g., a message in the form of “Low Battery” or some similar indication) is provided in display 30. Alternatively, a light (e.g., a light emitting diode), a sound (e.g., a beep), or some other signal may be used to indicate a low battery power condition. A user may install a new battery, connect an AC power source, or allow the sampling apparatus to shut down. Where the sampling apparatus shuts down, information concerning the elapsed actual run time (e.g., the total sampling time, the amount of cycle sampling time elapsed, etc.) is stored in memory and displayed when the sampling apparatus is again activated. Such information may be used to extrapolate sampling information over a complete run time, so that valuable sampling information is not lost due to battery depletion.

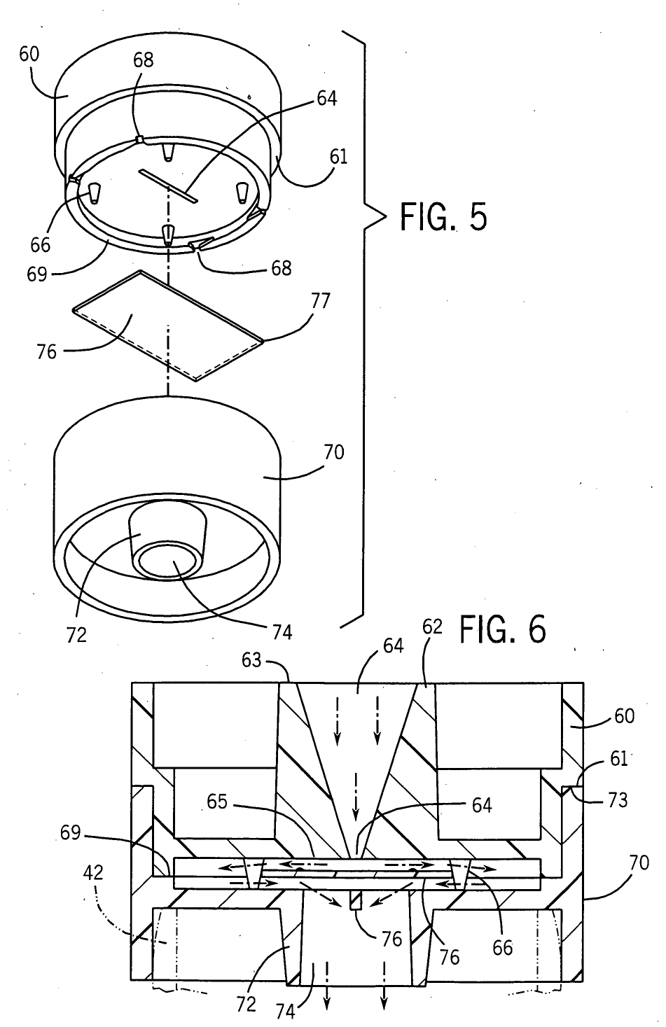

According to an exemplary embodiment, sampling apparatus 10 is configured to draw or pull air from the surrounding air or atmosphere through cassette 50. FIG. 5 shows a bottom perspective exploded view of cassette 50, and FIG. 6 shows a cross-sectional view of cassette 50 taken across line 6-6 in FIG. 5. Cassette 50 includes a top or upper portion 60, a lower or bottom portion 70, and a sampling plate or slide 76. Cassette 50 may be disassembled to allow for removal of sampling plate 76 after air sampling has been completed. According to the exemplary embodiment shown in the FIGURES, cassette 50 has a relatively cylindrical shape. According to alternative embodiments, other sizes and shapes for the cassette may be used (e.g., the cross-section may be a square, rectangle, triangle, oval, or other acceptable shape).

Top portion 60 includes an inlet or opening 62 that defines an aperture or hole 64 through which air passes when sampling apparatus 10 is in sampling mode. According to a preferred embodiment, the size of aperture 64 defined by inlet 62 narrows or tapers from a top 63 to a bottom 65 of inlet 62. Inlet 62 has a generally rectangular shape when viewed in the axial direction. The size (e.g., area) of the rectangle decreases from top 63 to bottom 65 in a substantially continuous manner. According to an exemplary embodiment, the width of inlet 62 (e.g., the longer side of the rectangle) remains constant between top 63 and bottom 65 while the length (e.g., the shorter side of the rectangle) decreases with increasing distance from top 63. As shown in FIG. 6, a cross-sectional view of inlet 62 shows that inlet 62 has a generally trapezoidal shape when viewed in a direction perpendicular to the central longitudinal axis of the cassette due to the decreasing size of inlet 62 with increasing distance from top 63.

According to an alternative embodiment, both the length and width of the rectangle forming the inlet decrease with increasing distance from the top of the inlet. According to alternative embodiments, the shape of the inlet may differ. For example, an inlet may have a generally circular, square, oval, or other shape when viewed in the axial direction. Such inlets according to alternative embodiments may or may not decrease in area with increasing distance from the top of the inlets. For example, where an inlet is provided with a generally circular cross-section viewed in the axial direction, the inlet may resemble a funnel (e.g., where the area decreases with increasing distance from the top of the inlet) or may resemble a cylinder (e.g., where such area does not decrease with increasing distance from the top of the inlet). Any of a variety of shapes and configurations may be provided for the inlet according to alternative embodiments, and the shape, size, and other characteristics may be optimized for a particular application.

Bottom portion 70 of cassette 50 includes an exit port or outlet 72 defining an aperture 74 through which air is drawn. A member 75 such as a bar is provided across outlet 72 to act as a stop to prevent items from being inserted beyond a predetermined point in the outlet 72. For example, where an adapter or other structure is provided within the outlet 72 (e.g., to mount the cassette 50 using the outlet 72 as a mounting structure), the adapter is prevented from extending through the outlet 72 in a manner that might cause damage to the sampling plate 76.

According to an exemplary embodiment, outlet 72 has a generally cylindrical shape such that a cross-section viewed in the axial direction has a generally circular shape. According to alternative embodiments, the size and shape of outlet 72 may differ. For example, according to an alternative embodiment, the outlet may have a generally square or oval shape when viewed in the axial direction. Further, the area of the outlet may remain constant or vary along its length (e.g., may taper).

The plate or slide 76 is provided intermediate top portion 60 and bottom portion 70 of cassette 50 (and hence between inlet 62 and outlet 72). When cassette 50 is assembled, a portion of top portion 60 is inserted within bottom portion 70 such that a first rim 61 provided on top portion 60 abuts a first rim 73 provided on bottom portion 70 and a second rim 69 provided on top portion 60 abuts a second rim 71 provided on bottom portion 70.

To secure plate 76 in relation to inlet 62, projections or protrusions 66 extend from top portion 70. Plate 76 is positioned between projections 66 such that projections 66 prevent lateral movement of plate 76. Additionally, corners 77 of plate 76 are received within cutouts 68 included in second rim 69 of top portion 60 to further restrict movement of plate 76 and to secure plate 76 in a relatively fixed relationship to inlet 62. Other means of securing the plate may be utilized according to alternative embodiments. For example, according to an alternative embodiment, either projections (e.g., projections 66) or cutouts (e.g., cutouts 68) may be provided. While the FIGURES illustrate a cassette 50 that includes a top portion 60 that is inserted into a bottom portion 70, according to an alternative embodiment, a bottom portion may be inserted into a top portion. According to another alternative embodiment, projections to secure the plate in place may extend from the bottom portion instead of or in addition to the top portion.

Plate 76 includes a substance or material in the form of a sampling medium 78 (e.g., an Agar medium having a relatively long shelf life, such as one year or greater) provided thereon. As shown in FIG. 4, medium 78 as provided has a generally rectangular shape and covers the majority of plate 76. One advantageous feature of medium 78 is that it is configured to maintain viable matter (e.g., biological organisms such as mold spores, bacteria, pollen, skin cells, insects and insect parts, or other airborne biological matter) in a living state so that the viable matter may be observed after the sampling operation is completed. According to an exemplary embodiment, the sampling medium may retain maintain viable matter in a living state for a period of approximately one month or longer. According to one embodiment, medium 78 is provided as a gel. According to another embodiment, medium 78 has a relatively sticky or tacky characteristic that may be configured to retain airborne matter.

According to other exemplary embodiments, the medium may be any other medium that may be configured to support viable matter. According to other exemplary embodiments, the medium may be any of a variety of other mediums that are not configured to maintain viable matter in a living state. According to these other exemplary embodiments, sampling apparatus 10 may be intended to sample non-biological or bacteriological matter in the air (e.g., asbestos particles, diesel emissions, copy toner, fiberglass, or other airborne matter), and therefore the viability of the airborne matter may be relatively unimportant to the sampling and analysis operations.

Airflow through cassette 50 is indicated generally in FIG. 6 by dashed arrows. As shown, air is drawn into cassette 50 through inlet 62 by impeller 80. The velocity of the air increases as it approaches bottom 65 of inlet 62. The air then travels around plate 76 and through outlet 72. At least a portion of airborne matter drawn into inlet 62 is impacted onto medium 78 when the air changes direction to travel around plate 76. Medium 78 retains the impacted matter to sample the amount and/or types of matter present in air being sampled.

According to an exemplary embodiment, cassette 50 is a disposable or non-reusable type cassette (e.g., cassette 50 is intended as a single-use type sampling device). After air sampling is complete, cassette 50 is disassembled to remove plate 76 from cassette 50 so that the matter retained in medium 78 may be quantified, tested, or otherwise analyzed. One advantageous feature of using a disposable cassette is that cleaning of the plate (e.g., removal of the medium and sampled matter and deposition of new or fresh medium material) is eliminated. By providing a disposable cassette, errors in sampling due to contamination of the cassette and/or to variations in application of new medium material to the plate may be reduced or eliminated. According to alternative embodiments, a reusable cassette may be provided. Such cassette may be cleaned and decontaminated between uses. The plate used may be the same or may differ between uses. For example, a user may provide a fresh or new plate that has not been used before with the cassette to reduce contamination and/or variations in the amount and/or type of media used. In another example, the media may be applied by the user before each use.

With reference to FIG. 1, an input device or user interface 20 is provided to allow programming of sampling apparatus 10. According to an exemplary embodiment, input device 20 is provided as a membrane switch and includes a number of buttons for entering or displaying information or performing a variety of other functions. As shown, input device 20 includes a start button 21, an on/off button 22, a set button 24, an up arrow button 25, a down arrow button 26, and a backlight button 28. According to alternative embodiments, other types of input devices and/or buttons may be provided. For example, a touchpad such as those found on laptop computers may be used. In another example, other types of buttons (e.g., such as those found on computer keyboards, telephones, and elsewhere) may be provided. Any type of input device may be provided to allow entry of user instructions or commands to sampling apparatus 10. The functions associated with the various buttons may also differ according to alternative embodiments. For example, while only up and down arrow buttons 25 and 26 are shown, left and right arrow buttons may also be provided. Other functionality may also be provided as desired.

A display 30 (e.g., a liquid crystal display, light emitting diode display, etc.) provides a visual indicator for sampling apparatus 10. For example, display 30 may be used during programming of the sampling apparatus to display menu choices, operating parameters, and the like. Display 30 may show a variety of messages, including messages that sampling has begun or terminated, that the sampling apparatus is active or inactive, that battery power is low, or any other message which would desirably be conveyed to a user of sampling apparatus 10. Any of a variety of information may be shown by display 30 depending on the particular configuration and functionality included in particular embodiments. Backlight button may be depressed to provide lighting to display 30 so that information provided on display 30 may be visible under low light conditions.

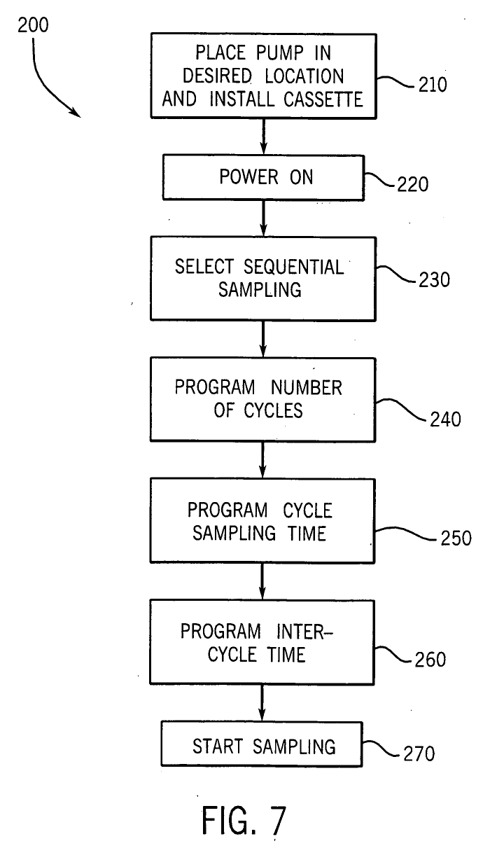

A method 200 of programming sampling apparatus 10 according to an exemplary embodiment is shown in FIG. 7. At a step 210, sampling apparatus 10 is placed or positioned at a desired location (e.g., a location where the air or other atmosphere is to be tested or analyzed). According to an alternative embodiment, programming of the sampling apparatus may occur prior to placing the sampling apparatus in the desired location. Cassette 50 is then positioned on sampling apparatus 10 (e.g., by inserting outlet 72 into aperture 40).

In a step 220, sampling apparatus 10 is turned on (e.g., by depressing on/off button 22 on input device 20). Turning the sampling apparatus on allows the battery to provide power to various components of sampling apparatus 10 as required (e.g., display 30, impeller 80, etc.).

In a step 230, a sequential or non-continuous sampling mode is selected by a user. In sequential sampling mode, impeller 80 is turned on and off at various points over a sampling period (e.g., five hours) in accordance with a programmed sampling schedule. During the sampling period, a single cassette 50 is used. One advantageous feature of using a sequential sampling mode with a number of sampling cycles (i.e., periods during which the impeller is activated) is that the air may be sampled at various points during the day using a single sampling cassette, which allows users to analyze airborne matter present over a longer period of time. To select the sequential sampling mode, up arrow 25 or down arrow 26 may be used to scroll between choices on display 30 to indicate a sequential sampling function (e.g., display 30 shows “SEQUENCE SET TIME” or some similar message). Set button 24 is then depressed to select the function shown on display 30.

In a step 240, the number of sampling cycles (e.g., the number of times the sampling apparatus will activate the impeller to sample air or surrounding atmosphere) is programmed by the user. For example, the up arrow 25 and down arrow 26 may be used to increase or decrease the number of sampling cycles. When the desired number of cycles is shown in display 30, set button 24 may be depressed to program sampling apparatus 10 with the desired number of cycles. According to an alternative embodiment, rather than selecting the number of cycles during which sampling will be performed, a user may select the total sampling time during which a number of sampling cycles are performed. The user may then select the cycle time and the interval between cycles. The sampling apparatus then samples in accordance with the individual cycle times until the total sampling time has been reached.

In a step 250, the sampling cycle time is programmed by the user. Setting the sampling cycle time allows the user to choose the amount of time impeller 80 operates for a particular cycle. The cycle time is selected in a manner similar to that described above with regard to choosing the number of cycles (e.g., arrow buttons are used to select the amount of time and then the set button is depressed when the desired time is displayed). According to an exemplary embodiment, the cycle time (e.g., five minutes) is the same for all cycles in a given sampling period (e.g., five hours). According to other alternative embodiments, the cycle times may vary throughout a sampling period. For example, cycle times may gradually increase from five minutes to ten minutes or may vary in other ways as may be desired. The method of programming the cycle time may be varied to accomplish non-uniform cycle time programming.

In a step 260, the inter-cycle or off time is programmed by the user. The inter-cycle time is the interval between sampling cycles during which impeller 80 is not operating. The inter-cycle time is programmed in a manner similar to that used to program the cycle time. Thus, the up arrow 25 and down arrow 26 are used to display a desired amount of inter-cycle time, and set button 24 is used to select the desired time.

In a step 270, sampling apparatus 10 begins sampling at the beginning of the sampling period. To begin the sampling period, a user depresses start button 21. If upon programming sampling apparatus 10 it is undesirable to sample in accordance with the programmed conditions, mode button 23 may be depressed to cancel the sampling. After sampling begins in accordance with the programmed parameters, start button 21 may again be depressed to end the sampling period before its programmed end. If the sampling period is allowed to proceed to its programmed end point, a termination message is presented on display 30 indicating that sampling is complete (e.g., by displaying a message such as “SAMPLE COMPLETE”).

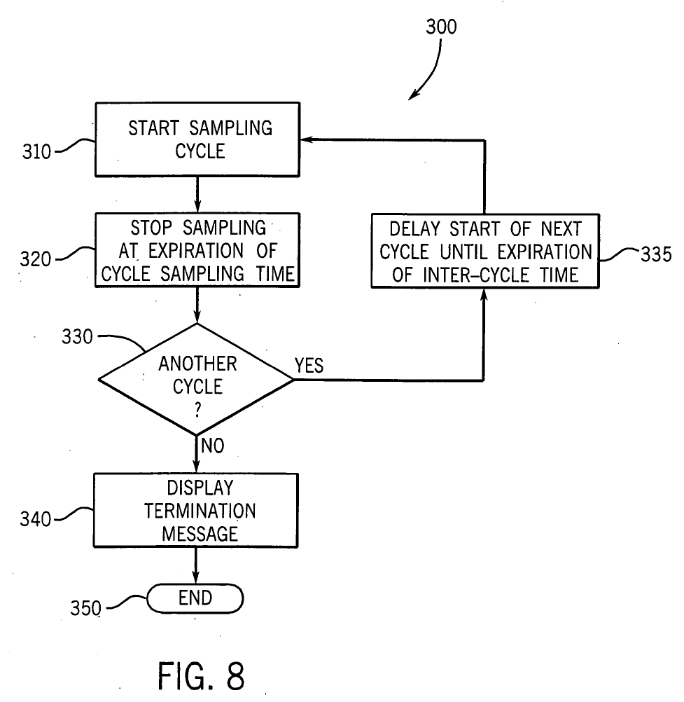

A method 300 of sampling in accordance with a sequential sampling mode according to an exemplary embodiment is shown in FIG. 8. In a step 310, the sampling period begins. At the start of the sampling period, the first cycle proceeds for the amount of time programmed in step 250 of FIG. 7. For example, if a cycle time of five minutes was programmed in step 250, the first cycle will proceed for five minutes, during which time impeller 80 continuously draws air into inlet 62 of cassette 50 at a substantially constant velocity. Upon expiration of the programmed cycle time, impeller 80 is stopped in a step 320. Thus, upon expiration of the cycle time, impeller 80 no longer draws air into inlet 62.

In a step 330, a decision is made as to whether the number of cycles programmed in step 240 of FIG. 7 has been reached. If the number of cycles programmed have been performed, a termination message (e.g., “SAMPLE COMPLETE”) is presented at display 30 in a step 340, after which the cycle ends in a step 350. If the number of cycles programmed have not been completed, impeller 80 remains inactive in a step 335 for the duration of the inter-cycle time programmed in step 260 of FIG. 7. After expiration of the inter-cycle time, another sampling cycle begins in step 310. The loop formed by steps 310, 320, 330, and 335 continues until the total number of sampling cycles have been completed, after which a termination message is displayed in step 340. According to an alternative embodiment in which the total sampling time is programmed instead of the number of cycles, decision step 330 may be replaced with a decision as to whether the total sampling time has elapsed. If the total sampling,time has elapsed, no additional sampling cycles are run, whereas if the total sampling time has not elapsed, additional sampling cycles are run until the total sampling time expires.

According to an alternative embodiment, the sampling apparatus may be programmed to perform a single sampling cycle. In this embodiment, a single sampling mode may be selected, and the user may then program sampling apparatus for a particular amount of sampling time (e.g., using the arrow and set buttons). Upon pressing the start button, the sampling apparatus samples continuously (e.g., the impeller continues to operate) until expiration of the sampling time period.

According to another alternative embodiment, the start of the sampling period may be delayed, such that the user need not press the start button to begin sampling. For example, the user may program into the sampling apparatus a start delay time (e.g., two hours). Upon expiration of the start delay time, the sampling apparatus begins sampling in accordance with the programmed parameters. One advantageous feature of such an embodiment is that a user need not be present to begin a sampling period. For example, the sampling period may be performed over a weekend, at night, or at another time when a user may not be present. In another example, the air or atmosphere may contain matter that may be unsuitable for human ingestion, and providing a start delay time feature may allow pre-programming and placement of the sampling apparatus before the air or atmosphere becomes hazardous.

The construction and arrangement of the elements of the air sampling apparatus as shown in the preferred and other exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements, the position of elements may be reversed or otherwise varied, and the nature or number of discrete elements or positions may be altered or varied (e.g., a different number of buttons or controls may be provided on an input device). It should be noted that the elements and/or assemblies of the system may be constructed from any of a wide variety of materials that provide sufficient strength or durability, including any of a wide variety of moldable plastic materials (such as high-impact plastic) in any of a wide variety of colors, textures and combinations. The order or sequence of any process or method steps may be varied or re-sequenced according to alternative embodiments. Other substitutions, modifications, changes and omissions may be made in the design, operating conditions and arrangement of the preferred and other exemplary embodiments without departing from the scope of the present invention.

What is claimed is:

1. An air sampling apparatus comprising:
a housing configured to have a sampling cassette coupled thereto;
an impeller provided within the housing and configured to draw air through the sampling cassette during a sampling cycle; and
a battery providing power to the impeller;
wherein the sampling apparatus may be programmed to perform a plurality of sampling cycles during a sampling period using a single sampling cassette, the plurality of sampling cycles being separated by a predetermined time interval.

2. The apparatus of claim 1, wherein the sampling apparatus may also be programmed to perform a single sampling cycle.

3. The apparatus of claim 1, wherein the apparatus is configured to sample air at a rate of between approximately 2 and 30 liters per minute.

4. The apparatus of claim 1, wherein the sampling cassette is disposable.

5. The apparatus of claim 1, wherein the sampling cassette includes a plate having a sample medium provided thereon.

6. The apparatus of claim 5, wherein the sampling cassette may be disassembled to remove the plate.

7. The apparatus of claim 5, wherein the sampling cassette includes an inlet and an outlet and the plate is provided intermediate the inlet and the outlet.

8. The apparatus of claim 7, wherein matter included in air entering the inlet impacts the sample medium during the plurality of sampling cycles.

9. The apparatus of claim 8, wherein matter from the plurality of sampling cycles impacts substantially the same area of the sample medium.

10. The apparatus of claim 8, wherein the sample medium is configured to retain viable matter included in the air entering the inlet.

11. The apparatus of claim 1, wherein the air sampling apparatus weighs between approximately 2 and 4 pounds.

12. The apparatus of claim 1, further comprising an input device coupled to the air sampling apparatus to enable programming of the sampling apparatus.

13. The apparatus of claim 12, wherein the input device comprises a membrane switch.

14. The apparatus of claim 1, wherein the impeller includes a motor and at least one impeller blade configured to draw air into the housing when the impeller blade is rotated by the motor.

15. The apparatus of claim 1, wherein the predetermined time interval separating the plurality of sampling cycles is programmed to be substantially constant throughout the sampling period.

16. The apparatus of claim 1, wherein the predetermined time interval separating the plurality of sampling cycles is programmed to vary during the sampling period.

17. The apparatus of claim 1, wherein the battery is a rechargeable battery.

18. The apparatus of claim 1, further comprising an aperture provided in the housing for attaching the air sampling apparatus to a means for elevating the air sampling apparatus above a surface.

19. An air sampling device comprising:
a casing having a battery provided therein;
means for attaching a sampling device to an exterior surface of the casing;
an impeller for drawing air through the sampling device when the sampling device is attached to the housing;
a rechargeable battery providing power to the impeller; and
a microprocessor configured to activate the impeller in accordance with a programmed sampling schedule, the programmed sampling schedule including a plurality of sampling cycles during which the impeller is activated and a plurality of inter-cycle periods during which the impeller is deactivated.

20. The air sampling device of claim 19, wherein the rechargeable battery is a nickel metal hydride battery.

21. The air sampling device of claim 20, wherein the rechargeable battery is a lithium ion battery or a nickel cadmium battery.

22. The air sampling device of claim 19, wherein the impeller draws air into the air sampling device at a substantially constant flow rate of approximately 15 liters per minute.

23. The air sampling device of claim 19, wherein the sampling apparatus may also be programmed to perform a single sampling cycle.

24. The air sampling device of claim 19, wherein the sampling device includes an inlet, an outlet and a plate having a sampling medium provided thereon, the plate positioned intermediate the intermediate the inlet and the outlet.

25. The air sampling device of claim 24, wherein airborne matter impacts the sampling medium when the impeller is activated.

26. The air sampling device of claim 19, wherein the air sampling apparatus weighs less than approximately 5 pounds.

27. The air sampling device of claim 19, further comprising an input device to enable programming of the air sampling device.

28. The air sampling device of claim 19, wherein each of the plurality of sampling cycles are substantially identical in duration.

29. The air sampling device of claim 19, wherein the means for attaching a sampling device comprises an aperture and a rubber grommet.

30. A portable air sampling apparatus configured for use with a disposable air sampling cartridge, the air sampling apparatus comprising:
a casing configured for removably coupling with the air sampling cartridge;
a battery providing power to the air sampling apparatus, the battery being rechargeable;
an impeller fan provided within the casing to draw air through the sampling cartridge when the impeller fan is rotated; and
a microprocessor configured to rotate the impeller fan in accordance with a programmed schedule, the programmed schedule including a plurality of sampling cycles during which the impeller fan is rotated and a plurality of inter-cycle periods during which the impeller fan is not rotated.

31. The air sampling apparatus of claim 30, wherein the battery is a nickel metal hydride battery.

32. The air sampling apparatus of claim 30, wherein the impeller draws air into the air sampling apparatus at a flow rate of between approximately 2 and 30 liters per minute.

33. The air sampling apparatus of claim 30, wherein the air sampling cartridge includes an inlet, an outlet and a plate having a sampling medium provided thereon, the plate positioned intermediate the intermediate the inlet and the outlet.

34. The air sampling apparatus of claim 30, wherein the air sampling apparatus weighs between approximately 2 and 4 pounds.

35. The air sampling apparatus of claim 30, wherein each of the plurality of sampling cycles are substantially identical in duration.
